(19) United States
(12) Patent Application Publication
(10) Pub. No.: US 2008/0100423 A1
(43) Pub. Date: May 1, 2008

(54) Power management in radio frequency devices

(75) Inventors: Randolph K. Geissler, Hudson, WI (US); Steven Arthur Lewis, Bloomington, MN (US); Scott Alan Nelson, Eagan, MN (US)

Correspondence Address: MERCHANT & GOULD PC, P.O. BOX 2903, MINNEAPOLIS, MN, 55402-0903, US

(73) Assignee: Geissler Technologies, LLC.

(21) Appl. No.: 11/981,030

(22) Filed: Oct. 30, 2007

Related U.S. Application Data
(60) Provisional application No. 60/855,902, filed on Oct. 31, 2006.

(51) Int. Cl. H04B 7/00

(52) U.S. Cl. 340/10.1

(57) ABSTRACT

The invention is directed to an improved RFID system. The system provides a tag having a power management unit that selectively powers a transmission unit to transmit at least a first signal having a first frequency. The tag can be configured to transmit a second signal having a second frequency as well. The power management unit selectively powers the transmission unit based on the level of power stored in the tag, a duty cycle associated with the tag, or a combination of the two.

### CROSS-REFERENCE

This application claims priority to U.S. Provisional Application Ser. No. 60/855,902, filed Oct. 31, 2006, entitled “POWER MANAGEMENT IN RADIO FREQUENCY DEVICES,” the disclosure of which is hereby incorporated by reference herein.

### TECHNICAL FIELD

The invention relates to a radio frequency identification system and more particularly to power management in a radio frequency identification system.

### BACKGROUND

Radio frequency identification (RFID) systems are well known. RFID systems can be active systems wherein the transponder includes its own power source, passive systems wherein the transponder receives all of its power from a base station, or semi-active systems wherein the transponder obtains power from both its own power source and from the base station. Since passive RFID systems do not require their own power source they are generally smaller, lighter, and cheaper to manufacture than active RFID systems. Consequently, passive systems are more commonly employed in RFID systems for the purpose of tracking as compared to active systems.

Passive RFID systems are generally either inductively coupled RFID systems or capacitively coupled RFID systems. Passive inductively coupled RFID systems are powered by the magnetic field generated by the base unit. Capacitively coupled systems, in contrast, are powered by the electric fields generated by the base unit. The present disclosure is applicable to both types of passive systems.

Passive inductively coupled RFID systems typically include a transponder that has a microprocessor chip encircled by, and electrically connected to, a metal coil that functions as an antenna as well as an inductance element. The metal coil receives radio frequencies from a base station and generates an electrical current that powers the microprocessor, which is programmed to retrieve stored data such as an identification number and transmit the data back to the base station. Capacitively coupled RFID systems include a capacitor to store power received at the metal coil. The stored power can be used to retrieve the stored data and to transmit the data back to the base station.

Active and semi-active RFID systems include a battery configured to power the microprocessor. Active tags also use the battery to power the antenna to transmit signals as well. Active and semi-active tags tend to have better read ranges than passive tags. The batteries in active tags typically have a battery life of up to five years. Semi-active tags, which consume less power, tend to last longer. However, even these tags must be replaced. Accordingly, an improved RFID system with a longer-lasting power source is desired.

Standard transmission frequencies have been established for RFID tags based upon their field of use. For example, 13.56 MHz is a standard radio frequency used for tracking manufactured goods, whereas 400 kHz is a standard radio frequency used for tracking salmon as they travel upstream to spawn. The standard radio frequency used for identification tags for livestock and other animals is currently 134.2 kHz. This relatively low radio frequency is advantageous because it can effectively penetrate water-containing objects such as animals.

On the other hand, the frequency does not have a high transmission rate. Therefore, current RFID systems do not work well where fast data transmission is required, such as in certain real time tracking applications of fast moving objects. More particularly, due to the inherent signal transmission delay associated with current RFID systems operated at 134.2 kHz, current systems cannot in certain circumstances effectively query and retrieve identification numbers, also commonly referred to as identification codes, from identification tags as the animals move rapidly past a particular point in space, such as when cattle move along a cattle chute commonly found at auctions or disassembly plants. Accordingly, an improved RFID system with faster data transmission capabilities is desirable.

### SUMMARY

The invention is directed to an improved RFID systems and methods of using the system. According to one aspect, an identification tag for an animal includes an antenna and a first circuit including a memory subunit, a power storage subunit, a power management subunit, and a first transmit subunit. The antenna generates an electrical current when a radio signal is received by the antenna and transmits the current to the power storage subunit. The power management subunit can deliver none, some, or all of the stored power to the first transmit subunit. The first transmit subunit is configured to transmit a first signal at a first frequency when it receives electrical current from the power management subunit.

In certain embodiments, the power management subunit is configured to determine a level of energy stored in the power storage unit (e.g., the capacitor) and to inhibit transmission of the first signal unless the level of energy stored in the power storage subunit is sufficient to transmit the first signal to the base unit successfully.

In certain embodiments, the power management subunit is configured to periodically enable transmission of the first signal according to a predefined duty cycle.

In certain embodiments, the tag also includes a second circuit having a second transmit subunit configured to transmit a second signal at a second frequency. In some embodiments, the power management subunit also can inhibit transmission of the second signal unless sufficient power is stored to successfully execute the transmission. In other embodiments, the second signal can be transmitted at intermittent intervals.

In general, a method of charging an identification tag for an animal includes receiving radio waves; and storing power from the received radio waves; and selectively powering the tag for transmission of reply signals.

In certain embodiments, the method also includes determining a level of power (e.g., the voltage) stored in the power storage unit; and supplying power from the power storage unit to the transmission unit only when sufficient power is stored to enable the transmission unit to retrieve data from memory and to transmit the data successfully.

In other embodiments, the energy stored in the battery is used to transmit a signal encoding the obtained data to the base unit at a later time or periodically over a period of time.

In some embodiments, the base unit continuously transmits radio waves over the geographic area to maintain the electromagnetic field. In other embodiments, however, the base unit periodically or intermittently transmits radio waves over the geographic region.

### BRIEF DESCRIPTION OF THE DRAWINGS

The accompanying drawings, which are incorporated in and constitute a part of the description, illustrate several aspects of the invention and together with the detailed description, serve to explain the principles of the invention. A brief description of the drawings is as follows:

FIG. 1 is a diagrammatic illustration of a conventional RFID system commonly used to track livestock;

FIG. 2 is a diagrammatic illustration of an RFID tag used in the RFID system of FIG. 1;

FIG. 3 is a diagrammatic illustration of an RFID system having features that are examples of inventive aspects of the present invention;

FIG. 4 is a diagrammatic illustration of an RFID tag used in the RFID system of FIG. 3;

FIG. 5 is a flowchart showing a communications process by which the RFID tag shown in FIG. 4 can communicate with the base station of the RFID system shown in FIG. 3;

FIG. 6 is a diagrammatic illustration of an RFID tag having a power management unit configured to determine power stored in the tag;

FIG. 7 is a flowchart showing a first power management process by which the RFID tag shown in FIG. 6 can communicate with a base station;

FIG. 8 is a diagrammatic illustration of an RFID tag having a power management unit configured to monitor a duty cycle for the tag;

FIG. 9 is a flowchart showing a second power management process by which the RFID tag shown in FIG. 8 can communicate with a base station;

FIG. 10 is a flowchart showing a third power management process by which an RFID tag can communicate with a base station;

FIG. 11 is a diagrammatic illustration of an RFID system having features that are examples of inventive aspects of the present invention; and

FIGS. 12-14 are a diagrammatic illustration of an RFID system having features that are examples of inventive aspects of the present invention, the diagrammatic illustrations shown at time periods T1, T2, and T3, respectively.

### DETAILED DESCRIPTION OF THE INVENTION

Definitions

As used herein, the term “animal” refers to macroscopic animals including vertebrates. Animals include domesticated animals, such as livestock and companion animals, and wild animals, such as game animals or fish. Livestock include animals such as swine (pig), piglet, sheep, lamb, goat, bovine (e.g., cow), fish (e.g., salmon) and, birds (e.g., chickens, ducks, and geese). This list of animals is intended to be illustrative only, and should not limit the scope of any of the following disclosure related to the present invention. As used herein, the term “track” refers to the identification, location, recording, and monitoring of animals or other objects of interest, for whatever purpose or reason. This definition is illustrative of uses of the present invention and is not intended to limit the scope of any of the following disclosure related to the present invention.

Tag, Method, and System

An identification tag for an animal, the tag including an antenna and a first circuit including a memory subunit, a power management subunit, and a first transmit subunit. The subunits are electrically connected to each other. The antenna is configured to generate an electrical current when a radio signal is received by the antenna. In particular, the antenna induces an electrical current from an electromagnetic field created by a base station. In certain embodiments, the tag includes a capacitor in which the power from the electrical current can be stored.

The power management subunit also can deliver none, some, or all of the stored power to the first transmit subunit. The first transmit subunit is configured to transmit a first signal at a first frequency when it receives electrical current from the power management subunit. The first signal encodes at least a first portion of any data within the memory subunit. Other embodiments transmit the first signal only for a specified period of time after receiving the first signal or transmit at intermittent intervals (e.g., transmit for a predetermined number of clock cycles every so many clock cycles).

In certain embodiments, the power management subunit is configured to determine a level of power stored in the power storage unit (e.g., the capacitor). The power management subunit can be coupled to the first transmit subunit to inhibit transmission of the first signal unless the level of energy stored in the power storage subunit is sufficient to transmit the first signal to the base unit successfully.

In certain embodiments, the tag also includes a second circuit electrically connected to the first circuit and to the antenna. The second circuit includes a second transmit subunit configured to transmit a second signal at a second frequency when it receives power (e.g., electrical current) from the power storage subunit (e.g., the capacitor). In some cases, transmission at the second frequency may require more power than transmission at the first frequency. The second signal encodes at least a second portion of data stored within the memory subunit. In some embodiments, the power management subunit also can inhibit transmission of the second signal unless sufficient power is stored to successfully execute the transmission. In other embodiments, the second signal can be transmitted at intermittent intervals.

A method of charging an identification tag for an animal includes providing a base unit including a transceiver configured to emit and receive radio wave signals. The radio wave signals generate an electromagnetic field over a geographic area extending outwardly from the base unit. The method also includes providing an identification tag having an antenna, a transmission unit, a power storage unit, and a memory storage unit. The method further includes receiving radio waves at the antenna when the tag is positioned within the geographic area of the electromagnetic field; storing power from the received radio waves in the power storage unit. Typically, the generated electrical energy is delivered to the power storage unit and stored as a voltage.

In certain embodiments, the method also includes determining a level of power (e.g., the voltage) stored in the power storage unit; and supplying power from the power storage unit to the transmission unit only when sufficient power is stored to enable the transmission unit to retrieve data from memory and to transmit the data successfully. In other embodiments, the power stored in the battery is used to transmit a signal encoding the obtained data to the base unit at a later time or periodically over a period of time.

In some embodiments, the base unit continuously transmits radio waves over the geographic area to maintain the electromagnetic field. In other embodiments, however, the base unit periodically or intermittently transmits radio waves over the geographic region.

The present invention includes an animal, the animal including coupled to an appendage (e.g., an ear) a tag according to the present invention.

### Illustrated Embodiments

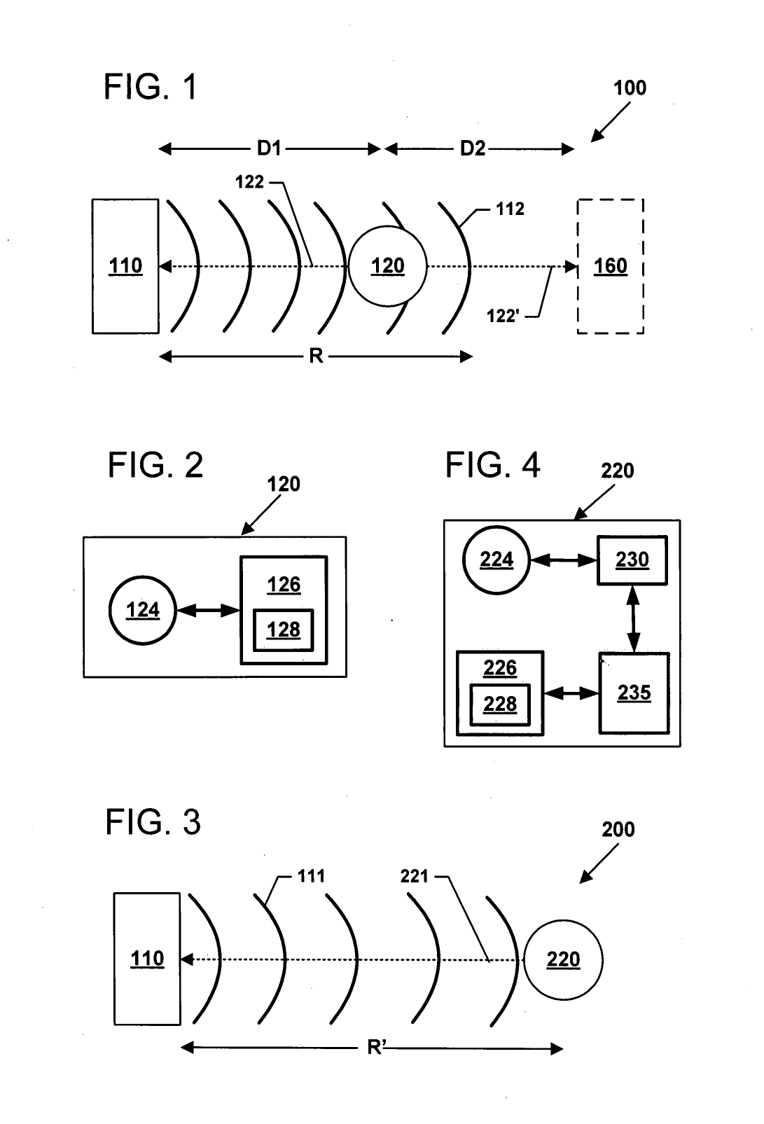

FIG. 1 illustrates a conventional RFID system 100 including a transceiver (e.g., a base station) 110 and a radio frequency identification (RFID) transponder (e.g., an RFID tag) 120. The transceiver 110 is configured to transmit a first query signal 112 over a distance R. The tag 120 is configured to receive the first query signal 112 when the tag is within the distance R, e.g., at a distance D1, from the transceiver 110. In an embodiment, the distance D1 is about two and one-half feet.

The tag 120 also is configured to emit a first reply signal 122 back to the base station 110 in response to receiving the query signal 112. In some embodiments, the tag 120 emits a first reply signal 122′ back to the transceiver 110. In other embodiments, the tag 120 emits a first reply signal 122 to a passive reader 160 located within a distance D2 of the tag 120. Typically, the tag 120 emits the first reply signal 122 by modulating the first query signal 112.

In general, the first query signal 112 energizes the transponder 120 to enable the transponder 120 to send the first reply signal 122. In some embodiments, the first query signal 112 and the first reply signal 122 are continuously carried over electromagnetic (i.e., radio) waves of a first frequency in a full duplex system. In other embodiments, the transponder 120 transmits the first reply signal 122 until out of power only after the transceiver 110 has stopped sending the first query signal 112 in a half duplex system.

The read range of a transponder 120 (e.g., the effective range of an RFID tag) is limited by the field or distance R needed to energize the transponder 120 (i.e., the distance the transponder 120 can be from the transceiver 110 and still induce a current from the first query signal 112). While steps can be taken to overcome poor signal modulation when the transponder 120 transmits a signal over a large distance, for example, with signal processing techniques, any transponder 120 located farther from the transceiver 110 than the distance R will be unable to harvest sufficient energy to transmit a signal successfully. For example, the transponder 120 may be unable to remain energized for the time necessary (e.g., 30.5 ms) to send a signal.

In an embodiment, RFID system 100 is configured to be used to track livestock, such as cattle. In particular, the base station 110 and transponder 120 are configured to transmit and receive radio waves at the current industry standard for RFID livestock tracking, which is 134.2 kHz.

As shown in FIG. 2, the transponder 120 includes an antenna 124 electrically coupled to a semiconductor chip 126. The antenna 124 is generally configured to receive the first query signal 112 (FIG. 1) and to generate an electric current from the first query signal 112. Typically, the antenna 124 is a wire loop (i.e., a metal coil) that functions as an inductor to generate the current. The antenna 124 also functions to transmit a reply signal 122 when the first query signal 112 is received.

The semiconductor chip 126 includes a memory 128 in which data can be stored. For example, the memory 128 of the semiconductor chip 126 can store an identification number/code associated with the animal being tracked. The generated current powers the semiconductor chip 126 to retrieve the data from the memory 128 and to transmit the retrieved data to the base unit 110 from the antenna 124 over the first reply signal 122.

Referring now to FIGS. 3-5, the read range of an RFID tag can be increased by selectively powering the tag 220 to emit a reply signal. FIG. 3 illustrates a first power management system 200 including the transceiver 110 described above and an RFID tag 220 having feature that are examples of inventive aspects of the present disclosure. The tag 220 has an effective read range extending over a distance R′, which is greater than the distance R.

In general, the effective read range R′ for the tag 220 depends at least partially on the size of the base station 110. For example, in an embodiment, the effective read range R′ for the tag 220 can extend up to about fifty inches when the base station antenna is about two feet by three feet. In another embodiment, the tag 220 has an effective read range R′ of about forty-two inches. In another embodiment, the tag 220 has a read range R′ of about forty-eight inches. In yet another embodiment, the read range R′ of the tag 220 is about thirty inches. In still yet another embodiment, the tag 220 has a read range R′ of about thirty-six inches.

FIG. 4 illustrates an example of a tag 220 having an antenna 224 and a semiconductor chip 226 with a memory storage 228. The tag 220 also includes a capacitor 230 for storing charge generated by the antenna 224 and a power management unit 235 electrically coupled to the capacitor 230 and the semiconductor chip 226. The power management unit 235 determines when the power received at the antenna 224 from the transceiver 110 is used to energize the tag 220.

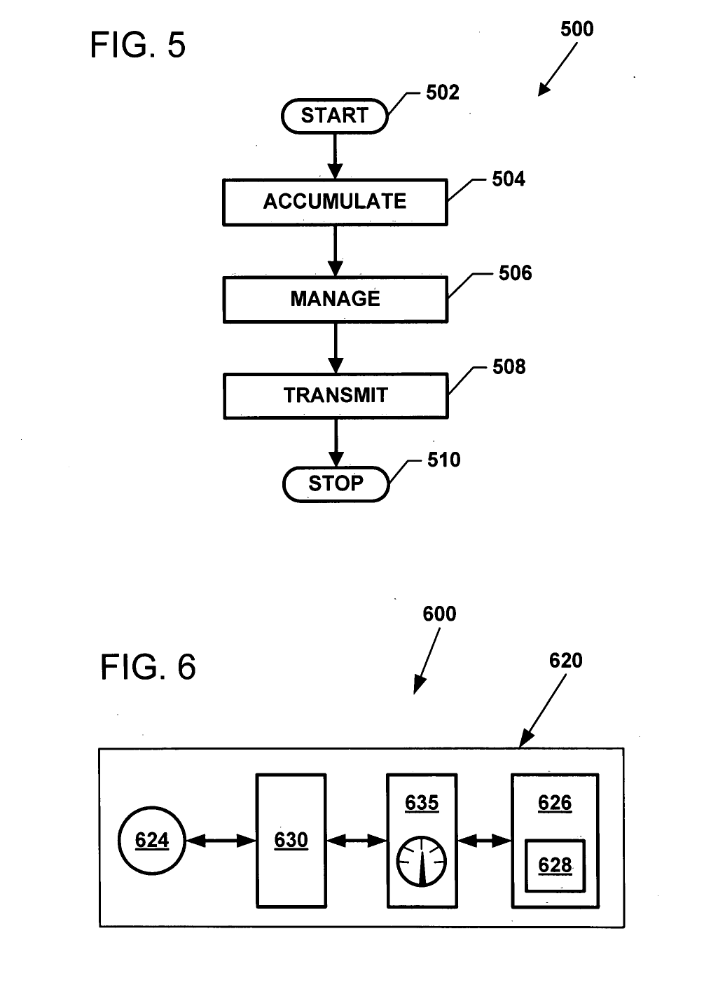

FIG. 5 illustrates an example communication process 500 by which the tag 220 communicates with the transceiver 110 in system 200. The communication process 500 initializes and begins at start module 502 and proceeds to an accumulate operation 504. In the accumulate operation 504, a first query signal 112, which is emitted by the transceiver 110 as described above, induces electrical current within the tag 220. The induced electrical energy is routed to the capacitor 230 of the tag 220 to be stored.

In a power management operation 506, the power management unit 235 of the tag 220 determines whether the semiconductor chip 226 of the tag 220 should be powered. In contrast to the tag 120, the tag 220 may not emit the first reply signal 122 immediately in response to receiving the first query signal 112. Rather, the tag 220 first accumulates power from the first query signal 112 and then broadcasts the first reply signal 222 in transmit operation 508 as determined by the power management unit 235. The communications process 500 completes and ends at stop module 510.

A potential advantage of this power management system and method is a longer effective read range of the tag 220. Because the tag 220 does not waste minute amounts of energy received when the tag 220 is farther from the transceiver 110 than the effective range distance R′ by attempting to broadcast on insufficient power, the tag 220 can pool the received energy into an amount usable by the tag 220.

Another advantage of this power management system and method is the ability to mitigate collisions between the reply signals 122 of multiple tags 220 that would otherwise interfere with one another. The power management units 235 of each tag 220 typically are not synchronized. Accordingly, each tag 220 will attempt to transmit a signal at a different time (statistically). In another embodiment, each tag 220 can be configured with slight differences so that tags 220 execute the transmit operation 510 at different times.

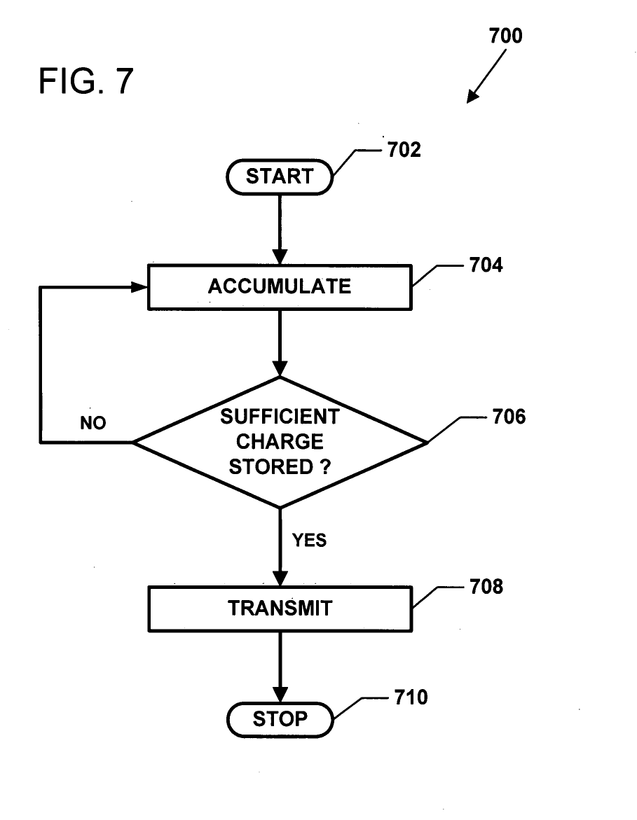

Referring to FIGS. 6 and 7, in some example systems 600, a tag 620 only transmits a reply signal, such as reply signal 122, when a predetermined amount of power has been stored in the tag 620. Typically, the predetermined amount of power corresponds with the level of power required to transmit a reply signal over a distance R′ to the transceiver 110 successfully.

FIG. 6 illustrates an example of a tag 620 including an antenna 624 and a semiconductor chip 626 that closely resemble antenna 124 and semiconductor chip 126 described above. The tag 620 also includes a capacitor 630 to store power generated by the antenna 624 and a power management unit 635. The power management unit 635 is electrically coupled to the capacitor and operably coupled to the semiconductor chip 626.

The power management unit 635 is configured to enable power stored in the capacitor 630 to energize the semiconductor chip 626 when a predetermined amount of power has been stored. In some embodiments, the power management unit 635 measures the amount of power stored in the capacitor 630 and compares the power to a stored threshold. In other embodiments, the power management unit 635 is configured to enable the power from the capacitor to pass through the power management unit 635 to the semiconductor 626 only when the capacitor 630 retains the predetermined amount of power.

In general, the power management unit 635 energizes the semiconductor 626 when sufficient power is stored in the capacitor 630 to enable the tag 620 to send a reply signal to a base station or other transceiver successfully. For example, in an embodiment, the power management unit 635 powers the semiconductor 626 when the capacitor has sufficient power to send a 134 KHz signal from about twenty-five to about forty-eight inches. In another embodiment, the power management unit 635 powers the semiconductor 626 when the capacitor has sufficient power to enable the tag 620 to broadcast a 134 KHz signal for about 30.5 ms. In another embodiment, the power management unit 635 powers the semiconductor 626 when the capacitor has sufficient power to enable the tag 620 to broadcast a 13.56 MHz signal for about 20 ms. In yet another embodiment, the power management unit 635 powers the semiconductor 626 when the capacitor has about 5 volts.

FIG. 7 illustrates a first power management process 700 using the tag 620. The power management process 700 initializes and begins at start module 702 and proceeds to an accumulate operation 704. In the accumulate operation 704, a first query signal 112, which is emitted by the transceiver 110 as described above, induces electrical current within the tag 620. The induced electrical energy is routed to the capacitor 630 of the tag 620 to be stored.

The process 700 then proceeds to a determine module 706 in which the power management unit 635 of the tag 620 determines whether sufficient power has been accumulated in the capacitor 630 to enable transmission of the first reply signal 122. In an embodiment, the tag 620 uses a comparator to determine whether the stored power is at least equal to a predetermined threshold. If the power management unit 635 determines that insufficient power has been stored, then the process 700 returns to accumulate operation 704 and begins again. Alternatively, if the power management unit 635 determines that sufficient power has been stored, then the process 700 proceeds to a transmit operation 708 in which the tag 620 broadcasts the first reply signal 122. The process 700 completes and ends at stop module 710.

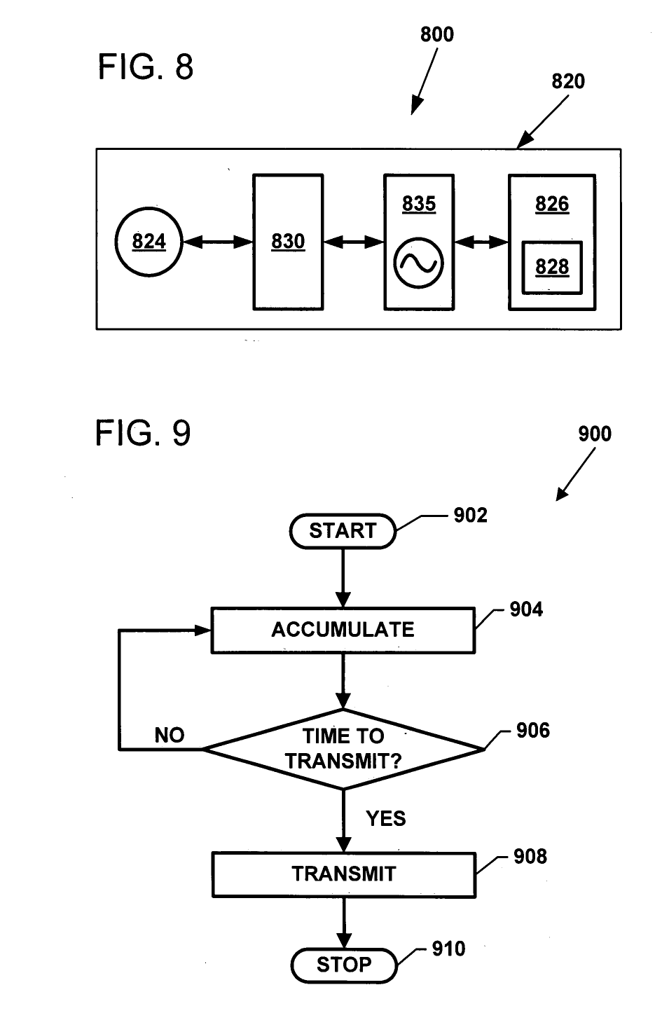

Referring to FIGS. 8 and 9, in some example systems 800, a tag 820 only transmits a reply signal, such as reply signal 122, according to a predefined duty cycle. The duty cycles determines when the tag 820 accumulates energy from query signals 112 and when the tag 820 expends energy by transmitting reply signals 122. Typically, the duty cycle is defined to enable the tag 820 to accumulate sufficient power to transmit a reply signal over a distance L′ to the transceiver 110 successfully before attempting to broadcast.

For example, FIG. 8 illustrates an example of a tag 820 including an antenna 824 and a semiconductor chip 826 that closely resemble antenna 124 and semiconductor chip 126 described above. The tag 820 also includes a capacitor 830 to store power generated by the antenna 824 and a power management unit 835. The power management unit 835 is electrically coupled to the capacitor and operably coupled to the semiconductor chip 826. The power management unit 835 is configured to only enable power stored in the capacitor 830 to energize the semiconductor chip 826 during predefined intermittent intervals.

In some embodiments, the power management unit 835 includes a clock and energizes the semiconductor chip 826 until drained every predetermined number of cycles of the clock. In other embodiments, the power management unit 835 energizes the semiconductor chip 826 for a predetermined period of time every predetermined number of cycles. For example, in an embodiment, the power management unit 835 would activate the semiconductor sufficient to send five or six reply signals 122 per second. As a comparison, a conventional tag typically transmits about thirty-two reply signals 122 per second.

The power management unit 835 effectively controls what percentage of the time the tag 820 will be energized to transmit a signal. For example, in an embodiment, the semiconductor 826 is activated during about 20% of the duty cycle and inactive during about 80% of the duty cycle. In another embodiment, the power management unit 835 enables the tag 820 to send a lower frequency signal about six times every second and a higher frequency signal about one time every two seconds.

FIG. 9 illustrates a second power management process 900 using the tag 820. The power management process 900 initializes and begins at start module 902 and proceeds to an accumulate operation 904. In the accumulate operation 904, a first query signal 112, which is emitted by the transceiver 110 as described above, induces electrical current within the tag 820. The induced electrical energy is routed to the capacitor 230 of the tag 220 to be stored.

The process 900 then proceeds to a determine module 906 in which the power management unit 835 of the tag 820 checks the duty cycle of the tag 820 to determine whether the tag 820 should be accumulating energy or transmitting the first reply signal 122. For example, the tag 820 can include a clock or a counter that determines whether the tag 820 should enter an accumulate cycle or a transmission cycle. In an embodiment, entering the accumulate cycle turns off all systems (e.g., circuits) within the tag 820 except for the power management unit 835. Entering the transmission cycle activates the memory of the tag 820.

If the power management unit 835 determines the tag 820 is scheduled to be accumulating energy, then the process 900 returns to accumulate operation 904 and begins again. Alternatively, if the power management unit 835 determines the tag 820 is scheduled to broadcast, then the process 900 proceeds to a transmit operation 908 in which the tag 820 broadcasts the first reply signal 122. The process 900 completes and ends at stop module 910.

In an embodiment, the tag 820 can be configured to accumulate power for about 0.5 seconds and to transmit a signal for about 30-50 milliseconds. In another embodiment, the tag 820 can be configured to accumulate power for about 90% of the duty cycle and to transmit a signal for about 10% of the duty cycle. In another embodiment, the tag 820 may be configured to transmit a signal for about two cycles (e.g., a length of time sufficient to transmit the data string twice).

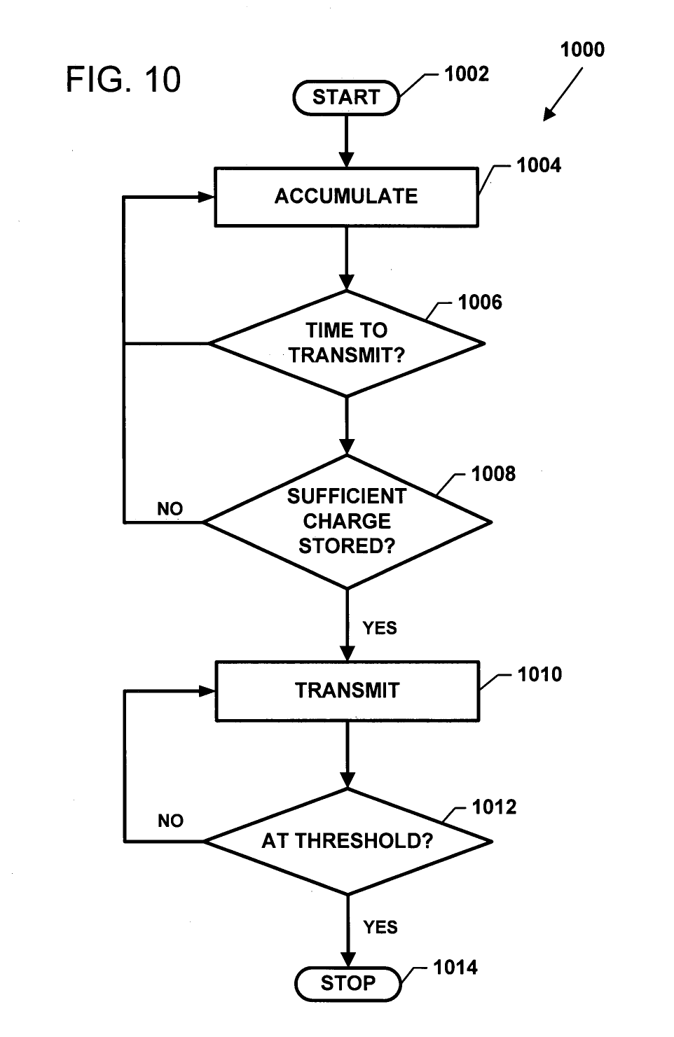

Referring now to FIG. 10, in certain embodiments, the above described power management methods can be combined. For example, a power management unit in an example tag can operate according to the power management process 1000 depicted in FIG. 10. The management process 1000 initializes and begins at start module 1002 and proceeds to an accumulate operation 1004. The accumulate operation 1004 is substantially similar to the accumulate operation 504 described above.

The process 1000 then proceeds to a first determine operation 1006 in which the power management unit of the tag checks the duty cycle of the tag to determine whether the tag should be accumulating energy or transmitting the first reply signal. If the tag should still be accumulating energy, then the process 1000 returns to the accumulate operation 1004. If the tag is scheduled to transmit a signal, however, then the process 1000 proceeds to a second determine operation 1008.

In the second determine module 1008, the power management unit of the tag determines whether sufficient power has been accumulated in the power supply to enable transmission of the first reply signal. If the power management unit determines that insufficient power has been stored, then the process 1000 returns to the accumulate operation 1004 and begins again. In an embodiment, the duty cycle can be altered when insufficient power is accumulated by the transmission stage of the duty cycle. Alternatively, if the power management unit determines that sufficient power has been stored, then the process 1000 proceeds to a transmit operation 1010 in which the tag broadcasts the first reply signal.

A third determine module 1012 determines whether a stop transmission threshold has been met. Typically, the tag only continues to transmit when sufficient power is available. While sufficient power is available, the management process 1000 cycles back to the transmit operation 1010. When the available power drops below a predetermined threshold, then the transmission operation 1010 completes and the process 1000 ends at stop module 1012. In another embodiment, the transmission operation 1010 ends in accordance with a duty cycle, even if sufficient power is available for successful transmission.

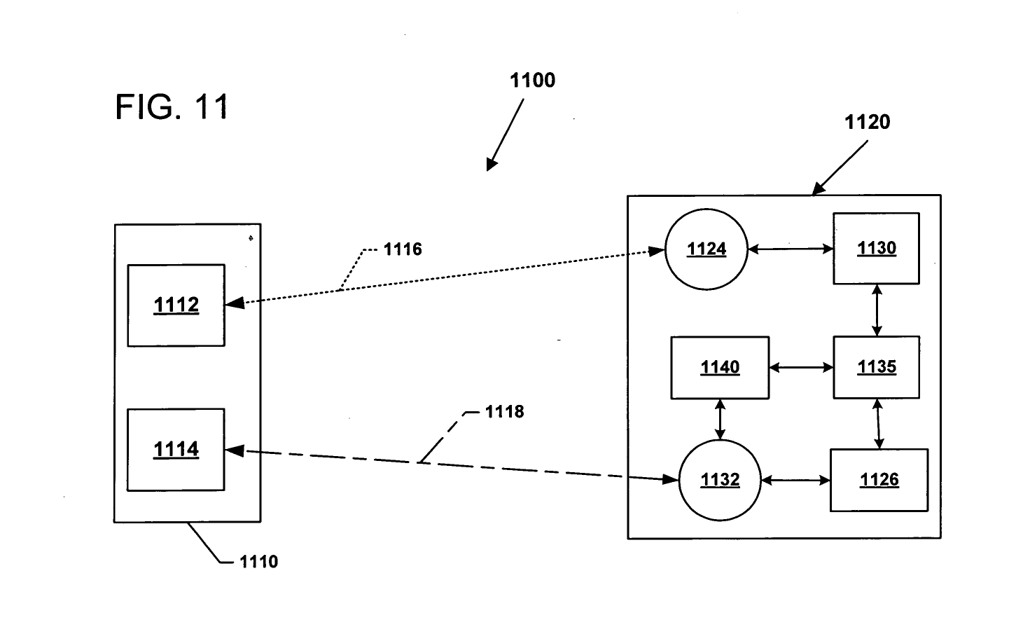

Referring now to FIG. 11, an RFID system 1100 having features that are examples of inventive aspects of the present invention is shown. In the depicted embodiment, the RFID system 1100 includes a base station 1110 and a transponder (e.g., tag) 1120. The base station 1110 includes a first device 1112 for transmitting and receiving signals at a first frequency 1116 and a second device 1114 for transmitting and receiving signals at a second frequency 1118. In an embodiment, the first frequency 1116 can be the standard frequency of 134 kHz and the second frequency 1118 can be a higher frequency (e.g., 13.56 MHz) than the first frequency 1114.

The transponder 1120 includes a first antenna 1124, e.g., a wire loop antenna, configured to receive and transmit on the first frequency 1116. The first antenna 1124 also functions as an inductor to generate an electrical current for powering a first semiconductor chip 1126. The first semiconductor chip 1126 can be programmed to retrieve a stored identification number and to transmit that identification number back to the first device 1112 of the base station 1110 over the first frequency 1116. In addition, the first semiconductor device 1126 can be programmed to transmit the identification number back to the second device 1114 of the base station 1110 over the second frequency 1118. In an embodiment, the transponder 1120 transmits the identification number over the second frequency 1118 via a second antenna 1132.

In certain embodiments, the transponder 1120 further includes a second semiconductor chip, 1140 that is electrically connected to the first semiconductor chip 1126. The second semiconductor chip 1140 is shown powered by the current generated by the metal wire loop antenna 1124. The second semiconductor chip 1140 may be configured to transmit a signal at the second frequency 1118 over the second antenna 1132.

In some embodiments, the second chip 1140 may include a writeable memory device for storing customizable programmable data. Second semiconductor chip 1140 can store any of a variety of data about an animal. For example, the health history, genetic characteristics, the date and location of sale, as well as other data related to an animal or object may be stored on the second semiconductor chip 1140.

Alternatively, such data can be written to a data storage location of the first semiconductor chip 1126. This data from the first semiconductor chip 1126 could be transmitted to the base station 1110 at the second higher frequency 1118 via the second semiconductor chip 1140. Alternatively, the customizable programmable data can be transmitted to the base station 1110 at the first frequency 1116 via the first semiconductor chip 1126.

Prior tags are generally arranged to receive a signal with an induction coil at the same frequency that they transmit through coil. In contrast, tag 1120 is configured so that power is induced within coil 1124 and energizes both semiconductor chips 1126, 1140. Preferably, the induction coil 1124 in tag 1120 is optimized for use with a standardized ISO frequency, which is typically approximately 134.2 kHz. Thus, the high frequency receiver 1114 in the base unit 1110 receiving the higher frequency data signal 1118 from tag 1120 does not require a separate transmitter.

Transmitting signals back to the base station 1110 over two different frequencies has numerous advantages. In an embodiment, the two frequencies may be provided to communicate different sets of data. In another embodiment, the lower frequency signal 1116 enables the RFID system 1100 to remain compatible with existing systems that operate at lower frequencies. In addition, due to some of the advantages of providing data over both signal frequencies, the antenna 1124 may be optimized to induce power rather than to transmit a reply signal.

Differences in frequency may provide different depths of penetration as balanced with signal or data density or transmission speed. A lower frequency signal, such as signal 1116, will penetrate through relatively more material than a higher frequency signal 1118. In contrast, higher frequency signals provide a greater transmission distance if the range is unobstructed. Further, higher frequency signals will be able to transmit a greater amount of data over the same amount of time, as compared to lower frequency signals.

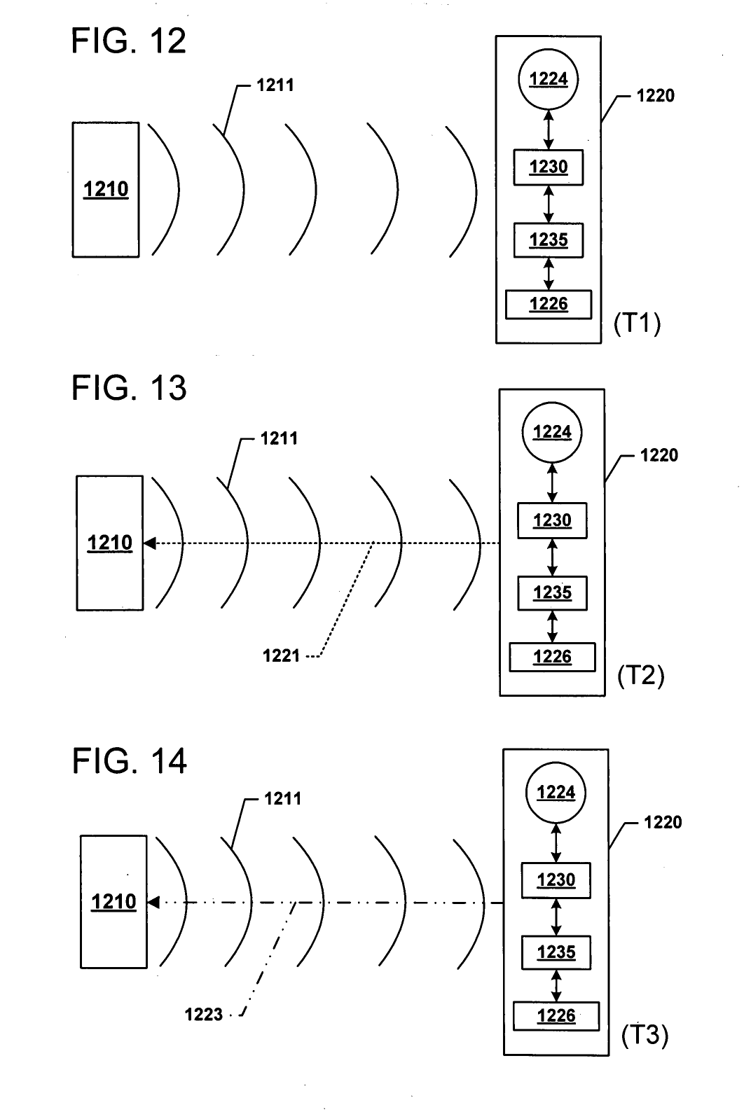

Referring to FIGS. 12-14, transmitting two signals and/or signals having increased frequencies, however, can require and expend more power than existing systems. In such systems, the power management systems and methods described above have even greater importance. For example, FIGS. 12-14 illustrate an example system 1200 in which a tag 1220 receives power from a base station 1210 and periodically transmits reply signals to the base station 1210 over two different frequencies. In the example shown, the base station 1210 continuously emits query signals 1211 (i.e., in accordance with a full duplex system). In other embodiments, however, the base station 1210 can switch between emitting query signals 1211 and listening for reply signals from the tag 1220 (i.e., in accordance with a half duplex system).

FIG. 12 shows the system 1200 at a time T1. At time T1, the power management unit 1235 of tag 1220 determines that the tag 1220 should not transmit a reply signal to the base station 1210. For example, in some embodiments, the tag 1220 determines the tag 1220 is scheduled to receive power from the base station 1210 without transmitting any reply signals. In other embodiments, the tag 1220 determines that the level of power stored in the power supply 1230 is less than a predetermined threshold. The antenna 1224 of tag 1220 generates power from the query signal 1211 and stores the generated power in the power supply 1230.

FIG. 13 shows the system 1200 at a later time T2. At time T2, the power management unit 1235 determines that tag 1220 should emit a first reply signal 1221 having a first frequency. For example, in some embodiments, the tag 1220 determines the tag 1220 is scheduled to emit a signal 1221 at the first frequency. In other embodiments, the tag 1220 determines the level of charge stored in the power supply 1230 meets the required threshold. In still other embodiments, the tag 1220 determines that the first reply 1221 is scheduled and that the threshold has been met.

FIG. 14 shows the system 1200 at another time T3. At time T3, the power management unit 1235 determines that tag 1220 should emit a second reply signal 1223 having a second frequency. In general, the second frequency is different than the first frequency. For example, in some embodiments, the first frequency is about 134 KHz and the second frequency is about 13.56 MHz. In a preferred embodiment, the query signal transmitted by the base station 1210 is transmitted at about 134 KHz.

In varying embodiments, the tag 1220 determines the tag 1220 is scheduled to emit the second signal 1223, the level of charge stored in the power supply 1230 meets the required threshold, or both. In other embodiments, the power management unit 1235 of the tag 1220 can determine that the tag 1220 should emit both of the first and second reply signals 1221, 1223 simultaneously.

In an example embodiment, the power management unit 1235 of the tag 1220 can monitor a duty cycle in which the tag 1220 accumulates energy about 70% of the time, emits a lower frequency signal, such as reply signal 1221, about 20% of the time, and emits a higher frequency signal, such as signal 1223, about 10% of the time. In another example embodiment, the power management unit 1235 of the tag 1220 can monitor a duty cycle in which the tag 1220 accumulates energy about 80% of the time, emits a lower frequency signal, such as reply signal 1221, about 20% of the time, and emits a higher frequency signal, such as signal 1223, about 10% of the time.

In another example embodiment, the power management unit 1235 of the tag 1220 allows energization of the semiconductor chip 1226 when sufficient power has been stored in a capacitor 1230 of the tag 1220 to power the semiconductor 1226 for 30.5 ms. In other example embodiment, the power management unit 1235 of the tag 1220 provides the stored energy to the semiconductor chip 1226 when at least 6 volts have been stored in a capacitor 1230 of the tag 1220.

What is claimed is:

1. A radio frequency identification (RFID) tag for identification of animals, comprising:
a first antenna;
a memory, the memory being configured to store data;
a storage unit, the storage configured to receive and store power from a current induced in the first antenna;
a transmission unit, the transmission unit being configured to retrieve the data stored in the memory and to transmit at least a portion of the data via the first antenna on a first carrier frequency; and
a power circuitry, the power circuitry configured to determine the power stored in the storage unit and to supply the power from the storage unit to the transmission unit at intermittent intervals only when sufficient power is stored to enable the transmission unit to retrieve data from memory and to transmit the data successfully.

2. The RFID tag of claim 1, further comprising a clock circuit, the clock circuit being operably coupled to the power circuitry, the clock circuit being configured to define the intermittent intervals at which the power circuit provides the power from the storage unit to the transmission unit.

3. The RFID tag of claim 1, wherein timing of the intermittent intervals is stored in the memory.

4. A method of operating an RFID tag having an antenna and a transponder, the method comprising:
entering an energy transfer phase for a first time period, the energy transfer phase including:
receiving a carrier signal at the antenna of the RFID tag;
inducing a current from the carrier signal received at the antenna;
storing power from the current induced at the antenna; and
entering a transmit phase for a second time period, the transmit phase including:
powering the transponder with the stored power; and
transmitting a response signal from the antenna.

5. The method of claim 4, further comprising alternating between the energy transfer phase and the transmit phase.

6. The method of claim 4, further comprising:
dividing the transmit phase into a first and second timeframe;
transmitting a first signal on only a first carrier frequency during the first time frame; and
transmitting a second signal on only a second carrier frequency during the second time frame, the second carrier frequency being different from the first carrier frequency.

7. The method of claim 4, wherein entering an energy transfer phase comprises deactivating the transponder.

8. The method of claim 4, wherein entering the transmit phase comprises activating the transponder.

9. A monitoring system comprising:
a base station, the base station configured to transmit a carrier signal and to receive response signals;
a first RFID tag, the first RFID tag including:
an antenna, the antenna configured to receive the carrier signal from the base station and to transmit a response signal to the base station;
wherein the first RFID tag begins transmitting the response signal to the base station after receiving the carrier signal from the base station; and
wherein the first RFID tag stops transmitting the response signal to the base station at a predetermined time.

10. The monitoring system of claim 9, wherein the RFID tag stops transmitting the response signal when the RFID tag receives an acknowledgement signal from the base station.

11. The monitoring system of claim 9, wherein the RFID tag further comprises a power storage unit to store power received from the carrier signal.

12. The monitoring system of claim 11, wherein the power storage unit comprises a capacitor.

13. The monitoring system of claim 11, wherein the first RFID tag begins transmitting the response signal only if sufficient power is stored in the power storage unit.

14. The monitoring system of claim 11, wherein any power remaining within the power storage unit after the predetermined time is conserved to support future transmissions.

15. The monitoring system of claim 9, wherein the first RFID tag transmits the response signal continuously for a fixed period of time.

16. The monitoring system of claim 9, wherein the first RFID tag further comprises a clock having a clock cycle.

17. The monitoring system of claim 16, wherein the first RFID tag transmits the response at periodic intervals based on the clock cycle.

18. The monitoring system of claim 9, wherein the first RFID tag delays for a predetermined delay period after receiving the carrier signal and before transmitting the response signal.

19. The monitoring system of claim 18, wherein the predetermined delay period is defined by a predetermined number of clock cycles.

20. A radio frequency identification (RFID) tag for identification of animals, comprising:
a first antenna;
a memory, the memory being configured to store data;
a storage unit, the storage configured to receive and store voltage from a current induced in the first antenna;
a transmission unit, the transmission unit being configured to retrieve the data stored in the memory, to transmit at least a portion of the data via the first antenna on a first carrier frequency, and to transmit at least a portion of the data via the first antenna on a second carrier frequency;
a power circuitry, the power circuitry configured to determine the voltage stored in the storage unit, and to supply the voltage from the storage unit to the transmission unit and to the memory at intermittent intervals only when sufficient voltage is stored in the storage unit to enable the transmission unit to retrieve data from memory and to transmit the data successfully.

21. The RFID tag of claim 20, wherein the intermittent intervals are defined by a value stored in the memory.

22. A method of operating an RFID tag having an antenna and a transponder, the method comprising:
receiving at the antenna of the RFID tag a carrier signal from a base station;
inducing a current from the carrier signal;storing a voltage from the induced current in the transponder;
powering the transponder with the stored voltage at predetermined intervals;
transmitting a first response signal on a first carrier frequency during some of the intervals during which the transponder is powered; and
transmitting a second response signal on a second carrier frequency during others of the intervals during which the transponder is powered.

23. The method of claim 22, further comprising determining a level of power stored in the transponder.

24. The method of claim 23, wherein transmitting the first response signal comprises transmitting the first response signal only if the level of power stored in the transponder is sufficient to enable successful transmission of the first response signal.

25. The method of claim 23, wherein transmitting the second response signal comprises transmitting the second response signal only if the level of power stored in the transponder is sufficient to enable successful transmission of the second response signal.

26. The method of claim 23, wherein powering the transponder at predetermined intervals comprises powering the transponder only when the level of power stored in the transponder is sufficient to enable successful transmission of at least one of the first response signal and the second response signal.

27. The method of claim 22, wherein powering the transponder at predetermined intervals comprises powering the transponder based on cycles of a clock.

28. The method of claim 22, wherein powering the transponder at predetermined intervals comprises powering the transponder only when a carrier signal is received from the base station.

29. A monitoring system comprising:
a base station, the base station configured to transmit a carrier signal and to receive response signals; and
a first RFID tag, the first RFID tag including:
an antenna, the antenna being configured to receive the carrier signal from the base station, and
a transponder, the transponder including:
a memory, the memory being configured to store data, a power storage unit, the power storage unit being configured to store power obtained from the carrier signal received from the base station,
a first transmission unit, the first transmission unit being configured to use the antenna to transmit a first response signal to the base station on a first carrier frequency only if a first level of power sufficient to successfully complete the transmission is stored in the power storage unit, and
a second transmission unit, the second transmission unit being configured to use the antenna to transmit a second response signal to the base station on a second carrier frequency only if a second level of power sufficient to successfully complete the transmission is stored in the power storage unit.
